(19) United States
(12) Patent Application Publication
(10) Pub. No.: US 2007/0056387 A1
(43) Pub. Date: Mar. 15, 2007

(54) Torque measuring device

(76) Inventor: Hajime Obikawa, Tokyo (JP)

Correspondence Address: Muramatsu & Associates, 114 Pacifica, Suite 310, Irvine, CA, 92618, US

(21) Appl. No.: 10/578,542

(22) PCT Filed: Nov. 10, 2004
(86) PCT No.: PCT/JP04/16659

§ 371 Date: May 5, 2006

(30) Foreign Application Priority Data
Nov. 14, 2003 (JP) 2003-384555

(51) Int. Cl. G01L 3/08

(52) U.S. Cl. 73/862.324

(57) ABSTRACT

Light irradiation detecting sections for irradiating laser light to reflectors of a rotational body and receiving the reflected light are downsized. A light transmitting and receiving device 21 has incident light receiving fibers 25a and 25b for guiding both incident light and reflected light and light irradiation detecting sections 11a and 11b, as well as polarization-maintaining fiber circulators 24a and 24b. The light transmitting and receiving device is structured such that reflected light is received through the same light path as the light path for outputting laser light from a laser light output device 20 through a branch connector 23. The polarization-maintaining fiber circulators 24a and 24b polarize and output the polarized laser light, as well as input reflected light through the same light path as the light path, through which the laser light is output, separate the reflected light from laser light from the laser light output device 20, and output the reflected light to a signal processing device 22 for obtaining torque.

### TECHNICAL FIELD

The present invention relates to a torque measuring device for measuring rotational velocity and torque of a rotational body in a non-contact and optical manner, particularly to a torque measuring device applied to combined cycle power generation plants and steam turbine plants.

### BACKGROUND ART

For example, combined cycle power generation plants are thermal power plants, in which a gas turbine and a steam turbine are combined to improve thermal efficiency and obtain high efficiency and high operability. That is, combined cycle power generation plants are structured such that exhaust heat from the gas turbine is guided to an exhaust heat recovery steam generator, and the steam turbine is driven by steam generated from the exhaust heat recovery steam generator, leading to improved thermal efficiency. In general, combined cycle power generation plants are composed of a plurality of units, each unit including a gas turbine and a steam turbine and having a single-shaft type structure to drive one electric generator by both the gas turbine and the steam turbine.

Even in such combined cycle power generation plants with high efficiency, after beginning of operation, aged deterioration occurs. In some units, thermal efficiency may be lowered. In view of management of thermal efficiency, it is important to diagnose the cause of lowering of thermal efficiency. In this case, it is necessary to comprehend whether the lowering of thermal efficiency is attributable to the gas turbine side, to the steam turbine side, or to other main components. In order to comprehend thermal efficiency, gas turbine output and steam turbine output should be comprehended.

Therefore, in order to detect gas turbine output and steam turbine output of the combined cycle power generation plants, optical torque measuring devices for detecting torque of a driving shaft (rotational body) of rotational equipment such as gas turbines and steam turbines have been developed. In the torque measuring devices, a pair of reflectors is provided on different locations of a rotational body in the axial direction, both reflectors are irradiated with laser light to detect reflected light from both reflectors, the rotational cycle of the rotational body is obtained based on cyclic strength and weakness of the reflected light, and the torque of the rotational body is detected based on the delayed time gap between a pair of the reflected light from both reflectors (for example, refer to Patent document 1).

Further, in Japanese Patent Application No. 2002-221347, a previous application of the applicant of the present invention, the light path of incident ray of laser light to the reflector and the light path of reflected ray from the reflector are arranged to be separated, so that loss of the reflected light is reduced and high output laser light is not needed.

Patent document 1: Japanese Patent Application Laid-open No. 2002-22564

### DISCLOSURE OF THE INVENTION

### Problems to be Solved by the Invention

In the torque measuring device of Patent document 1, though the incident light and the reflected light can be irradiated and received through the same light path. However, since the incident ray enters the reflector through a beam splitter provided on the single light path, and the reflected ray from the reflector also passes through the beam splitter on the same light path and is received in the direction different from the incident ray, light loss occurs every time light passes through the beam splitter. Meanwhile, in the device of Japanese Patent Application Laid-open No. 2002-221347, light loss can be reduced. However, since the light path of incident ray and the light path of reflected ray are separated, the number of optical system parts is increased, and the size of the optical system itself becomes large.

FIG. 4 is an explanation drawing of a light irradiation detecting section in the case that the light path of incident ray of laser light to the reflector and the light path of reflected ray are separated. A light irradiation detecting section 11 has an incident side lens 12 and a light receiving side lens 13. The incident side lens 12 receives laser light from the laser light output device through an incident-light optical fiber 14, and guides the laser light through a prism 15 to an irradiating condenser lens 16. The irradiating condenser lens 16 is divided into two symmetrical regions centering on the central axis. The incident light is irradiated to the surface region having a reflector 18 attached thereto on a rotational body 17 through one region of the irradiating condenser lens 16.

The reflected light reflected by the reflector 18 of the rotational body 17 enters the light receiving side lens 13 through the other region of the irradiating condenser lens 16, and is guided through a light receiving fiber 19 to the signal processing device. As above, the light path of incident light and the light path of reflected light are separated into respective different regions.

Since the irradiating condenser lens 16 facing the reflector 18 is divided into two regions accordingly, and the incident light path and the reflected light path are separated, the size of the irradiating condenser lens 16 itself becomes large. Further, the prism 15 for guiding the incident light to the irradiating condenser lens 16 becomes necessary. Consequently, the end of the light irradiation detecting section 11, which faces the reflector 18, irradiates laser light and receives reflected light, becomes large, and therefore measurement in a narrow and tight portion becomes difficult.

It is an object of the present invention to provide a torque measuring device capable of downsizing the light irradiation detecting section, which irradiates laser light to the reflector of the rotational body and receives the reflected light thereof.

### MEANS FOR SOLVING THE PROBLEMS

A torque measuring device of the present invention includes: a laser light output device for outputting laser light; a light transmitting and receiving device for irradiating the laser light from the laser light output device to the surface of a rotational body and receiving reflected light; reflectors, which are provided on the surface of the rotational body with a space in between axially and reflect the laser light irradiated from the light transmitting and receiving device in a given reflection pattern; and a signal processing device for obtaining torque of the rotational body based on the reflected light received at the light transmitting and receiving device. The light transmitting and receiving device includes: polarization-maintaining fiber circulators for polarizing the laser light from the laser light output device and outputting the polarized laser light, and for inputting reflected light of the polarized laser light through the same light path as the light path, through which the polarized laser light is output, separating the reflected light from the laser light from the laser light output device, and outputting the reflected light to the signal processing device; and light irradiation detecting sections, which are provided so that the light irradiation detecting sections face the surface regions of the rotational body provided with the reflectors, input polarized laser light from the polarization-maintaining fiber circulators, irradiate the polarized laser light to the surface regions of the rotational body, and detect reflected light and transmit the detected reflected light to the same light path as the light path, to which the polarized laser light from the polarization-maintaining fiber circulators is input.

### EFFECT OF THE INVENTION

According to the present invention, in the light irradiation detecting sections for irradiating laser light to the surface regions of the rotational body provided with the reflectors and for detecting the reflected light, polarized laser light from the polarization-maintaining fiber circulators is received as incident light, and the reflected light from the surface regions of the rotational body is transmitted to the polarization-maintaining fiber circulators. Accordingly, this incident/reflected light can be transmitted/received by using the same light path and the number of component parts of the light irradiation detecting sections can be relatively small, which allows reduction in size and weight of the light irradiation detecting section itself.

Since the size of the light irradiation detecting section itself can be reduced, the light irradiation detecting section can be installed in a narrow and tight portion. Therefore, torque measurement can be applied to the rotational body, where a precise torque measurement has not been allowed due to restriction of the size of the light irradiation detecting section in spite of demands for such a precise torque measurement.

### BRIEF DESCRIPTION OF THE DRAWINGS

FIG. 1 is a block configuration diagram of a torque measuring device according to an embodiment of the present invention;

FIG. 2 is an explanation drawing of a polarization-maintaining fiber circulator in the embodiment of the present invention;

FIG. 3(a) is an elevation view of a light irradiation detecting section in the embodiment of the present invention;

FIG. 3(b) is an elevation view of a light irradiation detecting section when a light path of incident ray of laser light to a reflector and a light path of reflected ray are separated; and

FIG. 4 is an explanation drawing of the light irradiation detecting section when the light path of incident ray of laser light to the reflector and the light path of reflected ray are separated.

### DESCRIPTION OF THE SYMBOLS

11: light irradiation detecting section, 12: incident side lens, 13: light receiving side lens, 14: incident light fiber, 15: prism, 16: irradiating condenser lens, 17: rotational body, 18: reflector, 19: light receiving fiber, 20: laser light output device, 21: light transmitting and receiving device, 22: signal processing device, 23: light branch connector, 24: polarization-maintaining fiber circulator, 25: incident light receiving fiber, 26: incident light receiving lens, 27: light detecting device, and 28: fixture.

### BEST MODES FOR CARRYING OUT THE INVENTION

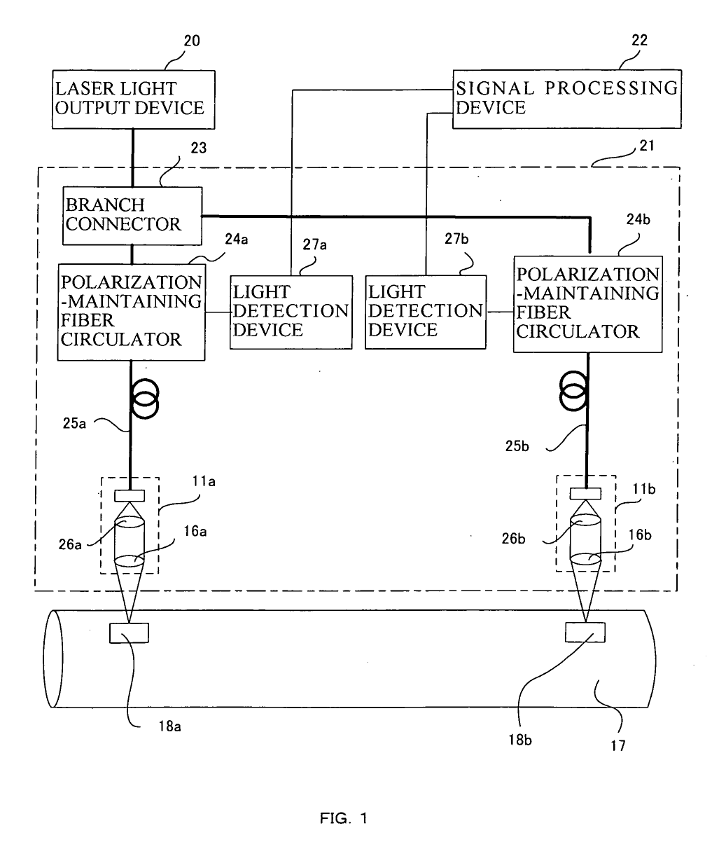

FIG. 1 is a block configuration diagram of a torque measuring device according to an embodiment of the present invention. The torque measuring device is composed of a laser light output device 20 for outputting laser light, a light transmitting and receiving device 21 for irradiating laser light from the laser light output device 20 to the surface of the rotational body 17 and receiving the reflected light, reflectors 18a and 18b, which are provided on the surface of the rotational body 17 with a space in the axial direction and reflect the laser light irradiated from the light transmitting and receiving device 21 in a given reflection pattern, and a signal processing device 22 for obtaining torque of the rotational body 17 based on the reflected light received at the light transmitting and receiving device 21.

The light transmitting and receiving device 21 is structured such that the reflected light is received through the same light path as the light path, through which laser light is output from the laser light output device 20 via a branch connector 23, and the light path of incident light and the light path of reflected light are a shared path. That is, for the light path between polarization-maintaining fiber circulators 24a and 24b and the rotational body 17, both the incident light and the reflected light are transmitted by using the same light path. The light transmitting and receiving device 21 has the polarization-maintaining fiber circulators 24a and 24b as well as incident light receiving fibers 25a and 25b for guiding both the incident light and the reflected light, and light irradiation detecting sections 11a and 11b.

Laser light output from the laser light output device 20 is branched at the light branch connector 23 of the light transmitting and receiving device 21 into two laser lights, each light guided to the polarization-maintaining fiber circulators 24a and 24b.

The polarization-maintaining fiber circulators 24a and 24b are provided correspondingly to a pair of reflectors 18a and 18b, which are provided on the surface of the rotational body 17 with a space in the axial direction, polarize the laser light from the laser light output device 20, and output the polarized laser light. The polarized laser lights from the polarization-maintaining fiber circulators 24a and 24b are guided by the incident light receiving fibers 25a and 25b and respectively input to the light irradiation detecting sections 11a and 11b.

The light irradiation detecting sections 11a and 11b are provided so as to face the surface regions of the rotational body 17 provided with reflectors 18, input the polarized laser light from the polarization-maintaining fiber circulators 24a and 24b, and irradiate the polarized laser light to the surface regions of the rotational body 17. That is, the light irradiation detecting sections 11a and 11b have incident light receiving lenses 26a and 26b, guide the polarized laser light guided by the incident light receiving fibers 25a and 25b as parallel light to irradiation condenser lenses 16a and 16b, condense the light at the irradiation condenser lenses 16a and 16b, and irradiate the light to the surface regions of the rotational body 17.

The pair of reflectors 18a and 18b is respectively provided on the surface of the rotational body 17, to which laser light is irradiated from the irradiation condenser lenses 16a and 16b. The reflectors 18a and 18b have, for example, a reflection pattern, in which a section reflecting the laser light and a section absorbing the laser light are formed in a form of barcode, and generate reflected light according to the reflection pattern when the laser light is irradiated.

The reflected light from the reflectors 18a and 18b enters the irradiation condenser lenses 16a and 16b of the light irradiation detecting sections 11a and 11b and is detected therein. The detected reflected light is condensed at the incident light receiving lenses 26a and 26b, guided by the incident light receiving fibers 25a and 25b, and input to the polarization-maintaining fiber circulators 24a and 24b. That is, the reflected light is transmitted through the same light path as the light path, through which the polarized laser light from the polarization-maintaining fiber circulators 24a and 24b is input in the reverse direction thereof.

When the reflected light is received, the polarization-maintaining fiber circulators 24a and 24b separate the reflected light from laser light from the laser light output device 20, and guide the reflected light to light detecting devices 27a and 27b. The reflected light, which is detected at the light detecting devices 27a and 27b, is output to a signal processing device 22. In the signal processing device 22, based on the reflected light reflected at the reflector 18 among the reflected light reflected at the surface of the rotational body 17, a rotational cycle and a torsion amount of the rotational body 17 are obtained by using a correlation function, and further a torque is obtained from the torsion amount. Incidentally, a driving device (not shown in the drawing) is provided for the light irradiation detecting sections 11a and 11b. The driving device moves the light irradiation detecting sections 11a and 11b in the direction of the focal axis, and adjusts the focal distance of the laser light irradiated from the light irradiation detecting sections 11a and 11b to the surface of the rotational body 17.

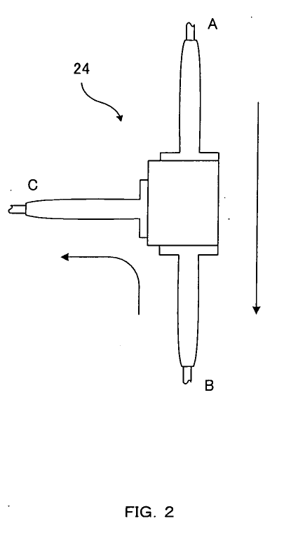

FIG. 2 is an explanation drawing of the polarization-maintaining fiber circulator 24. The polarization-maintaining fiber circulator 24 has a terminal A for inputting laser light from the laser light output device 20, a terminal B for outputting the laser light input through the terminal A and for inputting the reflected light from the reflector 18 of the rotational body 17, and a terminal C for outputting the reflected light input through the terminal B. The laser light input to the terminal A is magnetized and polarized to become polarized laser light inside the polarization-maintaining fiber circulator 24, and output through the terminal B. Therefore, the laser light output from the terminal B to the surface region of the rotational body 17 becomes polarized laser light obtained by polarizing the laser light from the laser light output device.

The polarized laser light is reflected by the reflector 18 in the surface region of the rotational body 17 to become a reflected light. The reflected light is input to the terminal B through the same light path as the light path, through which the polarized laser light is output. When the reflected light is input to the polarization-maintaining fiber circulator 24, distinction can be made between the reflected light and laser light input through the terminal A, since the reflected light is the polarized laser light. Therefore, the reflected light is output not to the terminal A but to the terminal C. Since the light detecting device 27 is connected with the terminal C, it is possible to output the reflected light to the signal processing device 22 by separating the reflected light from the laser light from the laser light output device 20.

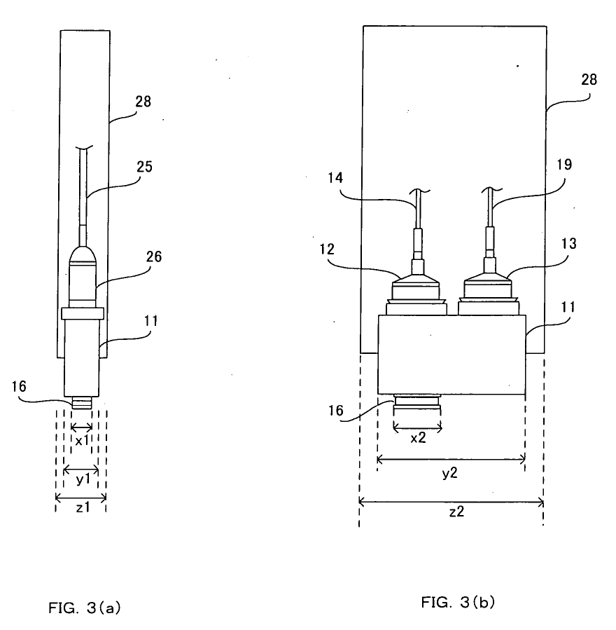

FIGS. 3(a) and 3(b) are explanation drawings of the light irradiation detecting section 11 in the torque measuring device of the present invention. FIG. 3(a) is an elevation view of the light irradiation detecting section 11 in the embodiment of the present invention, and FIG. 3(b) is an elevation view of the light irradiation detecting section 11 when the light path of incident ray of laser light to the reflector 18 and the light path of reflected ray are separated.

In FIG. 3(a), the diameter of the irradiation condenser lens 16 in the embodiment of the present invention is indicated by x1, the horizontal width of the light irradiation detecting section 11 is indicated by y1, and the horizontal width of the fixture is indicated by z1. Meanwhile, in FIG. 3(b), the diameter of the irradiation condenser lens 16 when the light path of incident ray and the light path of reflected ray are separated is indicated by x2, the horizontal width of the light irradiation detecting section 11 is indicated by y2, and the horizontal width of a fixture 28 is indicated by z2. The fixture 28 is intended to fix the light irradiation detecting section 11 when laser light is irradiated to the surface region of the rotational body 17.

The diameter of the irradiation condenser lens 16 in the present invention shown in FIG. 3(a) is about one half of that of the irradiation condenser lens 16 shown in FIG. 3(b). The reason is as follows. In the case of the light irradiation detecting section 11 of the present invention, incident light and reflected light pass through the same light path. Meanwhile, in the light irradiation detecting section 11 with separated light paths shown in FIG. 3(b), the irradiation condenser lens 16 is divided into two regions, and incident light and reflected light pass separately through the divided respective regions.

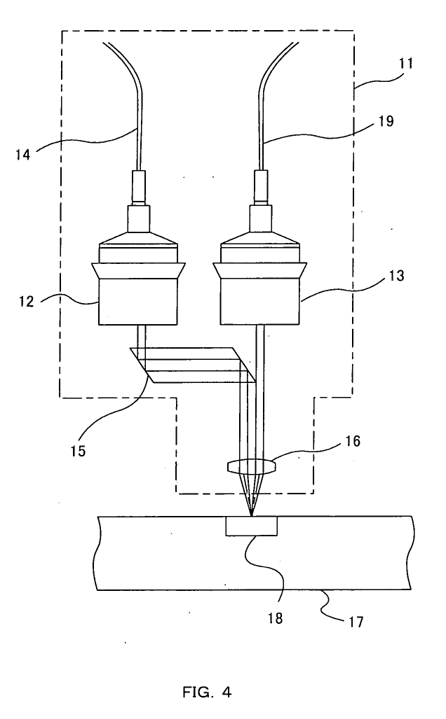

The horizontal width of the light irradiation detecting section 11 in the present invention shown in FIG. 3(a) is not more than a quarter of the horizontal width of the light irradiation detecting section 11 shown in FIG. 3(b). The reason is as follows. In the light irradiation detecting section 11 of the present invention, the prism 15 shown in FIG. 4 is not necessary, and the incident side lens 12 and the light receiving side lens 13 are substituted with the incident light receiving lens 26. Furthermore, since the size of the irradiation condenser lens 16 is about one half of the size of the irradiation condenser lens 16 shown in FIG. 3(b), the size of the incident light receiving lens 26 also becomes about one half. Incidentally, in the present invention shown in FIG. 3(a), since the prism 15 is not necessary, the size of the vertical width of the light irradiation detecting section 11 can be smaller compared to that in FIG. 3(b) as well as the horizontal width thereof. As in the horizontal width of the light irradiation detecting section 11, the size of the horizontal width of the fixture 28 of the present invention shown in FIG. 3(a) can be not more than a quarter of the size of the horizontal width of the fixture 28 shown in FIG. 3(b).

According to the embodiment of the present invention, since reflected light is arranged to be received through the same light path as the light path of the laser light output, the number of component parts can be reduced, and the size and the weight of the light irradiation detecting section 11 can be reduced. Thus, it becomes possible to realize a pen-like light irradiation detecting section 11, and to install the light irradiation detecting section 11 in a narrow and tight portion. Consequently, locations where a torque measurement can be performed can be significantly increased.

### INDUSTRIAL APPLICABILITY

Since the size of the light irradiation detecting section itself can be reduced, the light irradiation detecting section can be installed also at the narrow and tight location. Therefore, torque measurement can be applied to the rotational body, which has not allowed precise torque measurement since the light irradiation detecting section has not been allowed to be installed at a narrow and tight location due to restriction of the size of the light irradiation detecting section.

1. A torque measuring device comprising:
a laser light output device for outputting laser light;
a light transmitting and receiving device for irradiating the laser light from the laser light output device to the surface of a rotational body and receiving reflected light;
reflectors, which are provided on the surface of the rotational body with a space in the axial direction and reflect the laser light irradiated from the light transmitting and receiving device in a given reflection pattern; and
a signal processing device for obtaining torque of the rotational body based on the reflected light received at the light transmitting and receiving device,
wherein the light transmitting and receiving device includes:
polarization-maintaining fiber circulators for polarizing the laser light from the laser light output device and outputting the polarized laser light, and for inputting reflected light of the polarized laser light through the same light path as the light path, through which the polarized laser light is output, separating the reflected light from the laser light from the laser light output device, and outputting the reflected light to the signal processing device; and
light irradiation detecting sections, which are provided facing the surface region of the rotational body provided with the reflectors, for inputting polarized laser light from the polarization-maintaining fiber circulators, and irradiating the polarized laser light to the surface region of the rotational body, and for detecting the reflected light and transmitting the detected reflected light to the same light path as the light path, to which the polarized laser light from the polarization-maintaining fiber circulators is input.
